(19) United States
(12) Patent Application Publication
(10) Pub. No.: US 2026/0086425 A1
(43) Pub. Date: Mar. 26, 2026

(54) CAMERA ACTUATOR

(71) Applicant: JAHWA ELECTRONICS CO., LTD., Cheongju-si Chungcheongbuk-do (KR)

(72) Inventors: Chang Wook PARK, Incheon (KR); Jae keun SONG, Incheon (KR)

(73) Assignee: JAHWA ELECTRONICS CO., LTD., Cheongju-si Chungcheongbuk-do (KR)

(21) Appl. No.: 19/320,147

(22) Filed: Sep. 5, 2025

(30) Foreign Application Priority Data
Sep. 24, 2024 (KR) 10-2024-0129474

(51) Int. Cl. G03B 5/04; G03B 13/36

(52) U.S. Cl. CPC G03B 5/04; G03B 13/36; G03B 2205/0015; G03B 2205/0069

(57) ABSTRACT

A camera actuator, and a camera actuator having a reinforcing member for preventing a resin bleed out (RBO) phenomenon. The camera actuator may include: a first carrier; a second carrier accommodated inside the first carrier; an optical element accommodated in the second carrier, the second carrier being movable in a plane perpendicular to an optical axis of the optical element with respect to the first carrier; a plurality of balls provided between the first carrier and the second carrier; and ball rolling portions provided in the first carrier and the second carrier, in which the ball rolling portion may be configured such that a reinforcing member is inserted into the first carrier and/or the second carrier, and a recessed flat surface with which the ball comes into contact is formed in the reinforcing member.

### CROSS REFERENCE TO RELATED APPLICATION

The present application claims priority to Korean Patent Application No. 10-2024-0129474, filed on Sep. 24, 2024, the entire contents of which are hereby incorporated by reference in its entirety.

### FIELD

The present invention relates to a camera actuator, and more specifically, to a camera actuator having a reinforcing member for preventing a resin bleed out (RBO) phenomenon.

### BACKGROUND

As user needs for image capturing and the like increase, not only independent camera devices, but also camera modules or the like mounted in mobile terminals such as mobile phones and smartphones, are implemented with functions such as auto focus (AF) and optical image stabilization (OIS).

The auto focus (automatic focus adjustment) function refers to a function of generating a clear image on an image sensor (CMOS, CCD, etc.) provided at a rear end of a lens by linearly moving a carrier on which the lens and the like are equipped in an optical axis direction, thereby adjusting a focal distance with a subject.

In addition, the optical image stabilization function refers to a function of improving image clarity by adaptively moving the carrier on which the lens is equipped in a direction compensating for the shaking, in case where shaking of the lens occurs due to hand shaking.

One of the representative methods for implementing the auto focus or OIS function is to install a magnet (coil) on a movable body (carrier), and to install a coil (magnet) on a fixed body (housing or another type of carrier), and then to generate electromagnetic force between the coil and the magnet to move the movable body in the optical axis direction or in a direction perpendicular to the optical axis.

The OIS function compensates for shaking by moving back a movable body on which a lens assembly (or a lens) or an image sensor is equipped, in a first direction and/or a second direction which are two axes on a plane perpendicular to the optical axis, with respect to a relative fixed body.

In a conventional camera actuator equipped with the OIS function, a structure is mainly applied, in which a middle guide is applied between the movable body and the fixed body so that independent movement in the first direction and the second direction is implemented, and a ball is disposed between the movable body and the middle guide, and between the middle guide and the fixed body, respectively.

Since such a conventional actuator has a structure in which the movable body, the middle guide, and the fixed body are stacked, and respective balls are disposed therebetween, the height increases with respect to the optical axis direction.

Since the camera actuator is mounted on a main board of a mobile terminal such as a smartphone, the height increase of such an actuator directly leads to an increase in thickness of the mobile terminal, which results in a problem of being unsuitable for slimming of the mobile terminal.

As a technology to solve problems of such conventional technologies, a camera actuator in which a middle guide is omitted is known, as in Korean Laid-Open Patent Publication No. 10-2022-0128693 (prior patent 1) filed by the present applicant.

The actuator of the prior patent 1, as illustrated in FIG. 1, includes a first carrier 10, a second carrier 20, a base 30, a circuit board 40, an AF yoke 50, and a case 60, and the second carrier 20 is a movable body that moves in a combined direction of a first direction (x-axis direction) or a second direction (y-axis direction) with respect to the first carrier 10, and when a lens assembly 5 or an image sensor is mounted on the second carrier 20, an OIS is implemented by moving the lens or the image sensor according to the movement of the second carrier 20 to resolve external disturbance phenomena such as hand shaking.

That is, as illustrated in FIGS. 1 and 2, a first magnet MO1 and a second magnet MO2 are provided in the second carrier 20, which is the movable body, in directions perpendicular to each other, and a first coil C1 and a second coil C2 are installed at positions facing the first magnet MO1 and the second magnet MO2 in the first carrier 10, and when the power of an appropriate magnitude and direction is applied to the first coil C1, electromagnetic force is generated by interacting with the first magnet MO1 installed in the second carrier 20, and the generated electromagnetic force becomes a driving force, and the second carrier 20 moves in the first direction (x-axis direction) with respect to the first carrier 10.

In addition, when the power of an appropriate magnitude and direction is applied to the second coil C2, electromagnetic force is generated by interacting with the second magnet MO2 installed in the second carrier 20, and the generated electromagnetic force becomes a driving force, and the second carrier 20 moves in the second direction (y-axis direction) with respect to the first carrier 10.

Thus, even in a state where a separate middle guide is omitted, the actuator of the prior patent is capable of horizontal movement in the first direction and the second direction, thereby enabling implementation of the OIS function.

In this case, a support means 70 for physically supporting the second carrier 20 that moves with respect to the first carrier 10 is provided between the first carrier 10 and the second carrier 20, and as illustrated in the drawings, the support means 70 is implemented as a ball (B) that contacts the first carrier 10 and the second carrier 20, respectively.

As described above, when the ball B is provided between the first and second carriers 10 and 20, the second carrier 20 maintains a proper gap from the first carrier 10 through the ball B and is capable of linear movement with minimized frictional force through the moving or rolling of the ball B.

In addition, as illustrated in FIG. 2, one or more of the first carrier 10 or the second carrier 20 includes a pocket portion 15 that accommodates the ball B and prevents external separation of the ball B, and the pocket portion is configured as a flat surface to allow the ball B to move without limitation in the first direction and the second direction. Further, such a pocket portion is formed when the first carrier is formed by plastic injection molding.

However, when the flat surface of the pocket portion 15, on which the ball B rolls, is configured with a plastic material for injection molding, which is the material of the carrier, in case that an external impact is applied or the terminal falls and collides with the ground, dent damage occurs at the point where the ball member is in point contact, resulting in a problem in which the OIS function does not operate properly.

In order to solve such a problem, in Korean Laid-Open Patent No. 10-2023-0086441, a configuration in which reinforcing plates 222 and 312 are disposed in guide grooves corresponding to the pocket portions 15 illustrated in FIG. 3 has been proposed. As described above, when the reinforcing plates are disposed in portions where rolling motion occurs due to contact with the ball member, it becomes possible to reinforce rigidity, thereby making it possible to prevent dent damage.

In addition, in the guide grooves 15 where the ball members are placed, in order to reduce noise, minimize driving force, and improve rolling performance of the balls, a lubricant, collectively referred to as grease 70, is applied, but in this case, as illustrated in FIG. 4, the grease 70 acts as a surface contaminant that enters into gaps between surfaces of the insert-molded reinforcing members 11 and 21 and surfaces of the first carrier 10 and second carrier 20 molded by plastic injection, thereby accelerating a resin bleed out (RBO) phenomenon.

Here, the resin bleed out refers to a phenomenon in which specific components of the plastic injection material are separated and migrate to the surface, and this causes damage to adhesion strength with the reinforcing member that is in contact with the plastic injection material, which results in further expansion of the gaps, thereby causing a problem in which the grease leaks through the gaps.

That is, the grease 70 acts as a substance that hinders proper adhesion between the resin and the reinforcing member, thereby accelerating the resin bleed out phenomenon, and the viscosity of the grease affects surface flow and diffusion of the plastic injection-molded part, which may further worsen the resin bleed out phenomenon.

Further, when the grease deviates from its original position to another member such as a lens holder due to the resin bleed out, it may cause contamination inside the optical system, and particularly, as illustrated in FIG. 4, when it moves to an A space between the first carrier 10 and the second carrier 20, it may even lead to a malfunction of the OIS driving operation due to the viscosity of the grease.

### DOCUMENTS OF RELATED ART

(Patent Document 1) Prior Patent 1: Korean Laid-Open Patent Publication No. 10-2022-0128693 (published on Sep. 22, 2022)

(Patent Document 2) Prior Patent 2: Korean Laid-Open Patent Publication No. 10-2023-0086441 (published on June 15, 2023)

### SUMMARY

The present invention has been devised to solve the above-described problem, and an object thereof is to provide a camera actuator capable of preventing a resin bleed out (RBO) phenomenon, by inserting a reinforcing member having a structure for improving structural rigidity into a first carrier and a second carrier so that grease filled in a ball rolling portion does not deviate from its original position, and further increasing the rigidity of the first carrier and the second carrier to implement high durability and precision.

In addition, another object is to provide a camera actuator having the first carrier and the second carrier suitable for mass production, by concentrating a magnetic flux of magnets attached to the first carrier and the second carrier and increasing a suction force with the magnets of the first carrier and the second carrier, thereby enabling stable actuator driving.

To achieve the objects, there is provided a camera actuator, according to an embodiment of the present invention. The camera actuator may include: a first carrier; a second carrier accommodated inside the first carrier; an optical element accommodated in the second carrier, the second carrier being movable in a plane perpendicular to an optical axis of the optical element with respect to the first carrier; a plurality of balls provided between the first carrier and the second carrier; and ball rolling portions provided in the first carrier and the second carrier, in which the ball rolling portion may be configured such that a reinforcing member is inserted into the first carrier and/or the second carrier, and a recessed flat surface with which the ball comes into contact is formed in the reinforcing member.

In an embodiment of the present invention, a first carrier reinforcing member may be inserted into the first carrier, a second carrier reinforcing member may be inserted into the second carrier, and the recessed flat surface with which the ball comes into contact may be formed in the first carrier reinforcing member and the second carrier reinforcing member.

In addition, the first carrier reinforcing member may be a plate-shaped member having a U-shape when viewed in a plane, and the second carrier reinforcing member may be a plurality of plate-shaped members, which are respectively disposed at locations where a plurality of balls are positioned.

In this case, the first carrier reinforcing member and the second carrier reinforcing member may be formed of a non-magnetic metal material.

In addition, the recessed flat surface of the first carrier reinforcing member and the second carrier reinforcing member, which is applied to an embodiment of the present invention, may be formed by a drawing process.

Further, the first carrier, which is applied to an embodiment of the present invention, may have a suction yoke inserted into a position adjacent to the first carrier reinforcing member.

In addition, the suction yoke may be an AF magnet yoke, a first-direction OIS suction yoke, and a second-direction OIS suction yoke.

Next, the second carrier reinforcing member may be formed of at least two, and an OIS magnet yoke may be inserted between two of the second carrier reinforcing members in the second carrier.

Further, the OIS magnet yoke inserted in the second carrier may be a first-direction OIS magnet yoke and a second-direction OIS magnet yoke.

According to an embodiment of the present invention, a resin bleed out (RBO) phenomenon is prevented by the reinforcing members inserted into the first carrier and the second carrier, and, in addition, the structural rigidity of the first carrier and the second carrier may be increased.

As a result, grease filled in the ball rolling portion does not deviate from its original position, and the rigidity of the first carrier and the second carrier is increased, thereby enabling the implementation of high durability and precision.

In addition, it becomes possible to concentrate the magnetic flux of the magnets attached to the first carrier and the second carrier, and to increase the suction force with the magnets of the first carrier and the second carrier, thereby enabling stable driving of the actuator, and also making it possible to mass-produce the first carrier and the second carrier efficiently.

### BRIEF DESCRIPTION OF THE DRAWINGS

FIG. 1 is a perspective view illustrating an overall configuration of an actuator in the related art.

FIG. 2 is a perspective view illustrating a relationship between a first carrier and a second carrier of the actuator in the related art.

FIG. 3 is a cross-sectional view illustrating a structure of a reinforcing member of the actuator in the related art.

FIG. 4 is a conceptual diagram illustrating a problem of the structure of the reinforcing member of the actuator in the related art.

FIG. 5A is a perspective view illustrating a coupled state of a first carrier and a second carrier according to an embodiment of the present invention.

FIG. 5B is a perspective view illustrating a coupled state of a first carrier and a second carrier according to an embodiment of the present invention.

FIG. 6 is a perspective view illustrating an assembled state of the first carrier and the second carrier of FIG. 5B.

FIG. 7 is a perspective view of viewing the second carrier in FIG. 6 from the bottom surface.

FIG. 8A is a perspective view illustrating a molded state of the first carrier according to an embodiment of the present invention.

FIG. 8B is a perspective view illustrating a molded state of the first carrier according to an embodiment of the present invention.

FIG. 8C is a perspective view illustrating a molded state of the first carrier according to an embodiment of the present invention.

FIG. 9A is a perspective view illustrating a molded state of the second carrier according to an embodiment of the present invention.

FIG. 9B is a perspective view illustrating a molded state of the second carrier according to an embodiment of the present invention.

FIG. 9C is a perspective view illustrating a molded state of the second carrier according to an embodiment of the present invention.

FIG. 10A is a cross-sectional perspective view illustrating a structure of a carrier according to an embodiment of the present invention.

FIG. 10B is a bottom perspective view illustrating a structure of a carrier according to an embodiment of the present invention.

FIG. 11A is a cross-sectional perspective view illustrating a structure of a carrier according to an embodiment of the present invention.

FIG. 11B is cross-sectional view illustrating a structure of a carrier according to an embodiment of the present invention.

FIG. 11C is a cross-sectional view illustrating a structure of a carrier according to an embodiment of the present invention.

FIG. 12A is a plan view illustrating an insert structure according to an embodiment of the present invention.

FIG. 12B is a plan view illustrating an insert structure according to an embodiment of the present invention.

FIG. 13A is a perspective view illustrating an insert structure of the first carrier according to an embodiment of the present invention.

FIG. 13B is a perspective view illustrating an insert structure of the first carrier according to an embodiment of the present invention.

FIG. 13C is a perspective view illustrating an insert structure of the first carrier according to an embodiment of the present invention.

FIG. 13D is a perspective view illustrating an insert structure of the first carrier according to an embodiment of the present invention.

FIG. 14A is a perspective view illustrating an insert structure of the second carrier according to an embodiment of the present invention.

FIG. 14B is a perspective view illustrating an insert structure of the second carrier according to an embodiment of the present invention.

FIG. 14C is a perspective view illustrating an insert structure of the second carrier according to an embodiment of the present invention.

FIG. 14D is a perspective view illustrating an insert structure of the second carrier according to an embodiment of the present invention.

### DETAILED DESCRIPTION OF EMBODIMENTS

Hereinafter, embodiments of the present disclosure will be described with reference to the accompanying drawings. Prior to this, it is clarified that terms or words used in the present specification and the claims shall not be construed as being limited only to dictionary definitions, and based on the principle that an inventor may appropriately define the concept of a term to best describe his or her own invention, they shall be construed in the meaning and concept conforming to the technical spirit of the present invention.

Accordingly, it should be understood that the embodiment described in the present specification and the configuration illustrated in the drawings are merely one most preferred embodiment, and are not intended to represent all of the technical spirit of the present invention, and that, at the time of filing the present application, various equivalents and modified examples capable of substituting the embodiments may be made.

In the attached drawings, although an embodiment in which AF and OIS functions are integrated together is illustrated as an actuator according to an embodiment of the present invention, this is only one embodiment, and it is of course possible that the actuator of the present invention may be implemented as an actuator only for the OIS function, depending on the implementation type.

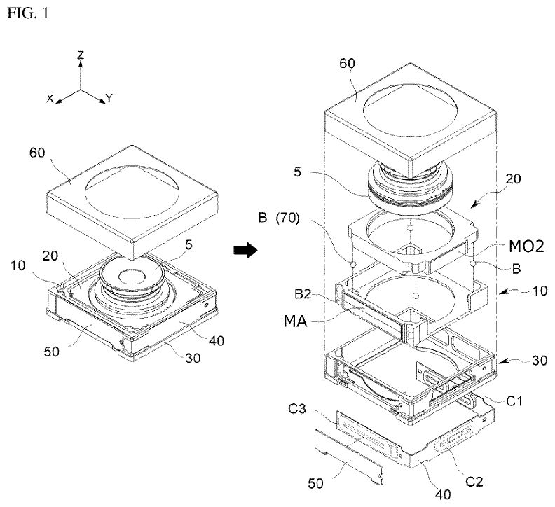

Before describing the present invention, when direction-related terms are first defined, the -z-axis direction is, as in FIG. 1 of the related art, an incident optical axis direction, which is a direction in which light is incident to a lens assembly 5, and the x-axis direction and y-axis direction, which are two directions perpendicular to the optical axis direction (z-axis direction), are directions in which a second carrier 700 moves by OIS driving so that shaking of the incident optical axis caused by hand shaking during shooting is compensated, and in the following description, the x-axis direction is referred to as a first direction, and the y-axis direction is referred to as a second direction, but this is merely one example, and it is of course possible that either one of the x-axis direction or the y-axis direction may be the first direction, and the other may be the second direction.

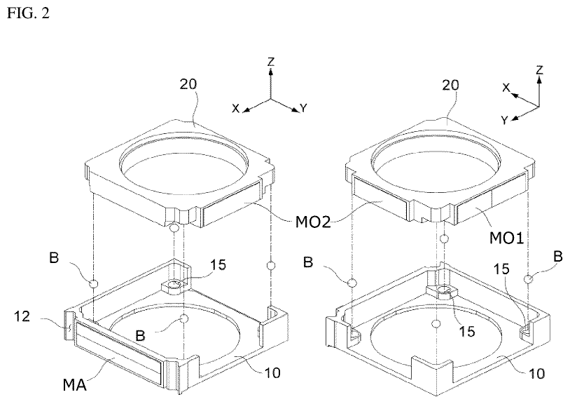

Further, the configuration of the present invention, as in FIG. 2 of the related art, relates to a first carrier 10 and a second carrier 20 constituting an actuator, and the first carrier and the second carrier of the present invention may be configured to include a base 30, a circuit board 40, an AF yoke 50, and a case 60, as illustrated in FIG. 1.

As in the related art illustrated in FIG. 1, the first carrier and the second carrier of the present invention are received within a space formed by the base 30, which is a basic frame structure, and the case 60 functioning as a shield can.

Hereinafter, with reference to the drawings, a preferred embodiment of the present invention will be described in detail.

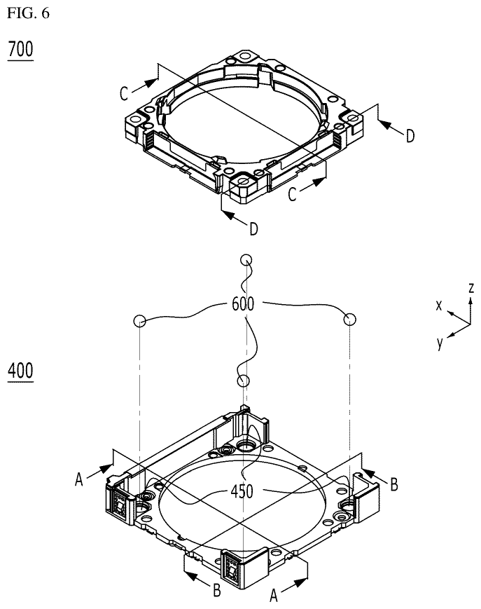

FIGS. 5A and 5B are perspective views illustrating a coupled state of a first carrier and a second carrier according to an embodiment of the present invention, and FIG. 5B is a perspective view viewed in a state of rotating FIG. 5A 90 degrees clockwise when viewed in a plane, and FIG. 6 is a perspective view illustrating an assembled state of the first carrier and the second carrier in FIG. 5B.

With reference to FIGS. 5A to 7, the embodiment of the present invention relates to a camera actuator in which a second carrier 700 (corresponding to 20 in FIG. 1) is accommodated inside a first carrier 400 (corresponding to 10 in FIG. 1), and an optical element is accommodated in the second carrier, so that the second carrier 700 may be moved on a plane perpendicular to an optical axis of the optical element with respect to the first carrier 400, and a plurality of balls 600 are provided between the first carrier and the second carrier, and the first carrier 400 and the second carrier 700 have ball rolling portions 450 and 750.

That is, the second carrier 700 is a movable body that moves in a combined direction of the first direction or the second direction with respect to the first carrier 400, and when a lens assembly (5 in FIG. 1) or an image sensor (not illustrated) is mounted as an optical element on the second carrier 700, the OIS function that resolves external disturbance phenomenon such as hand shaking is implemented as the lens or image sensor moves according to the movement of the second carrier 700.

In this respect, the second carrier 700 corresponds to a movable body that relatively moves with respect to the first carrier 400, and from a corresponding perspective, the first carrier 400 corresponds to a relative fixed body.

Further, a plurality of balls 600 that physically support the second carrier 700 moving with respect to the first carrier 400 are provided between the first carrier 400 and the second carrier 700.

When the balls 600 are provided between the first carrier 400 and the second carrier 700 as described above, the second carrier 700 maintains a proper gap from the first carrier 400 through the balls 600, and may linearly move more flexibly with minimized frictional force by moving or rolling of the balls 600, thereby allowing further improvement in noise reduction, driving force minimization, and driving precision.

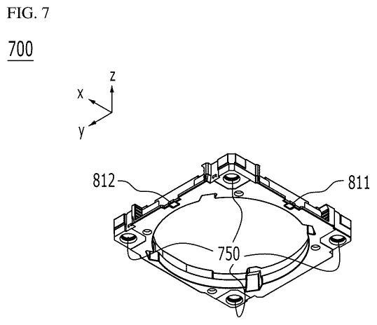

Further, as illustrated in FIG. 6, a ball rolling portion 450 that accommodates the balls 600 and prevents the balls 600 from separating externally may be formed in the first carrier 400, and, as illustrated in FIG. 7, a ball rolling portion 750 may also be formed on a bottom surface portion of the second carrier 700.

Furthermore, as illustrated in FIGS. 5A and 5B, in the second carrier 700, which is a driving body, spaces (positions denoted by dotted indicator lines) in which a first OIS magnet MO1 and/or a second OIS magnet MO2 may be installed may be provided, and the spaces in which the first OIS magnet MO1 and the second OIS magnet MO2 are installed are formed in mutually perpendicular directions on a planar view, as illustrated in FIG. 5B.

In addition, on one side surface of the first carrier 400, as illustrated in FIG. 5A, a space (a position denoted by a dotted indicator line) in which an AF magnet MA is installed may be formed.

Meanwhile, as described above with reference to FIG. 1 in the description of the related art, the first carrier 400 (corresponding to 10 in FIG. 1) and the second carrier 700 (corresponding to 20 in FIG. 1) are received in the base 30, and the first coil C1 and second coil C2 are installed at positions facing the first OIS magnet MO1 and the second OIS magnet MO2, and when the power of an appropriate magnitude and direction is applied to the first coil C1, an electromagnetic force is generated by interaction with the first OIS magnet MO1 installed in the second carrier 20, and the second carrier 700 moves in the first direction (x-axis direction) with respect to the first carrier 400 by using the electromagnetic force as a driving force.

In addition, when the power of an appropriate magnitude and direction is applied to the second coil C2, an electromagnetic force is generated by interacting with the second OIS magnet MO2 installed in the second carrier 700, and the generated electromagnetic force becomes a driving force, and the second carrier 700 moves in the second direction (y-axis direction) with respect to the first carrier 400.

Accordingly, even in a state where a separate middle guide is omitted, the actuator including the first carrier 400 and the second carrier 700 may perform horizontal movement in the first direction and the second direction, thereby enabling the implementation of the OIS function.

In addition, as illustrated in FIG. 5A, a space in which an AF magnet MA may be installed is provided on one side surface of the first carrier 400, and, as previously described with reference to FIG. 1 in the related art, when the power is applied to an AF coil C3 disposed on the base 30 to face the AF magnet MA, the first carrier 400 moves linearly in an optical axis direction (z-axis direction) with respect to the base 30, by an electromagnetic force generated between the AF coil C3 and the AF magnet MA. In this case, balls for rolling motion may be disposed between a groove rail formed on an inner surface of the base 30 and a guide rail 419 formed on an outer surface of the first carrier 400.

As the first carrier 400 moves in the optical axis direction in this manner, the second carrier 700 accommodated in the first carrier 400 also moves in the optical axis direction together with the first carrier 400, such that the lens assembly 5 equipped on the second carrier 700 linearly moves in the optical axis direction, thereby implementing an auto focus function by adjusting a focal distance between an image sensor (not illustrated) provided at a rear end of the actuator and the lens assembly 5.

In the above embodiment, the case in which the first carrier 400 moves in the optical axis direction to implement the auto focus function is described, but the first carrier 400 of the present invention may also be used in a state in which it is fixed to or integrated with the base 30, and such an actuator may be used in systems where the auto focus function is not required or is implemented in a different way. That is, in case where the auto focus function is replaced with movement of the image sensor or software-based processing instead of movement of the optical system, the first carrier 400 may operate the second carrier 700 of the present invention in a fixed state, thereby enabling the implementation of only the OIS function.

The present invention is characterized by the first carrier and the second carrier among the configurations of the actuator described above, and, as previously described, the ball rolling portion 450 that accommodates the balls 600 and prevents external separation of the balls 600 may be formed in the first carrier 400, and, as illustrated in the perspective view of FIG. 7, which shows the second carrier 700 in FIG. 6 viewed from the bottom surface, the ball rolling portion 750 may also be formed on the bottom surface portion of the second carrier 700.

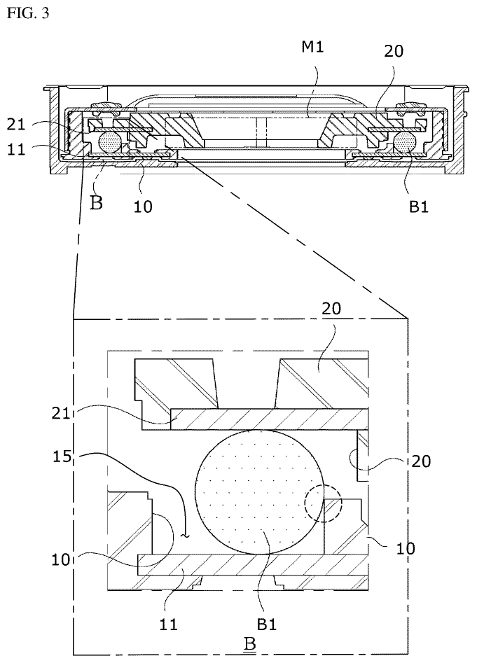

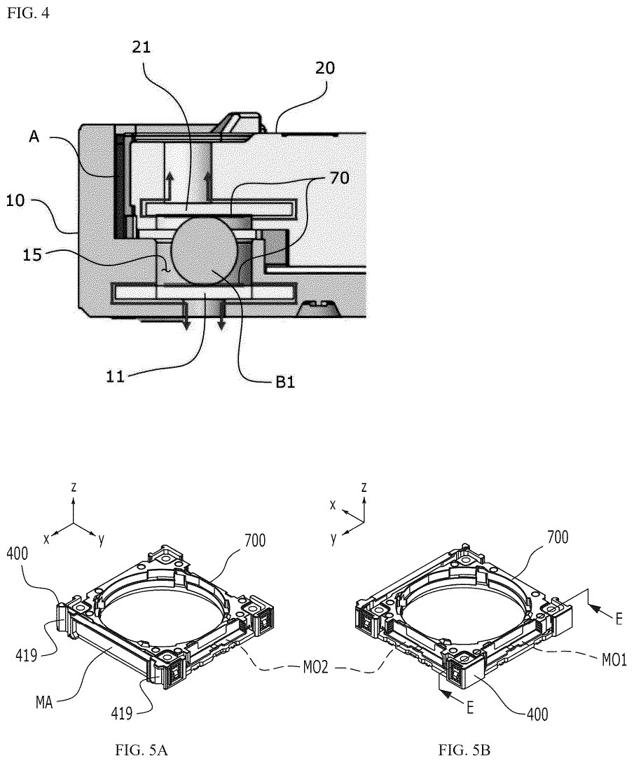

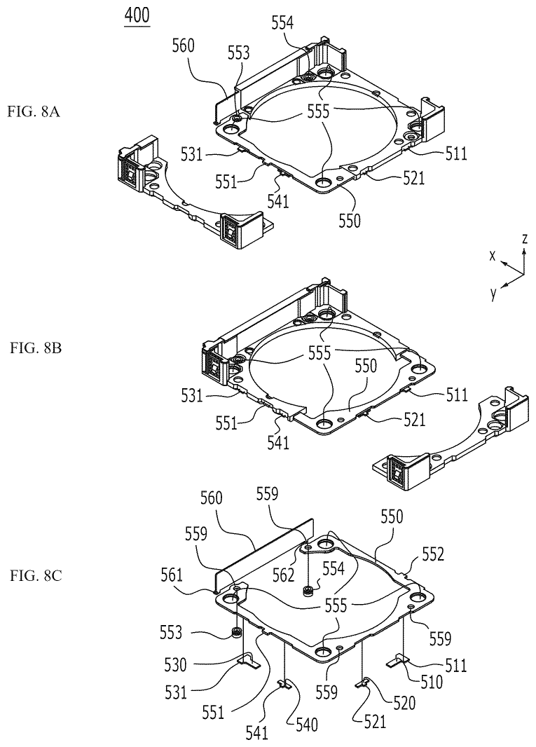

Further, such ball rolling portions 450 and 750 correspond to the pocket portion (15 in FIG. 2) or the guide groove (15 in FIG. 3) of the related art described above, but the ball rolling portions of the present invention, as illustrated in FIGS. 8A to 14D, are characterized in that a reinforcing member is inserted into the first carrier 400 and/or the second carrier 700, and a recessed flat surface in contact with the ball is formed on the reinforcing member, which will be described in detail hereinafter with reference to those drawings.

FIGS. 8A to 8C are perspective views illustrating a molded state of the first carrier 400 according to an embodiment of the present invention, in which FIG. 8A illustrates an internal structure in a state of cutting along the A-A cross-section of FIG. 6, FIG. 8B illustrates an internal structure in a state of cutting along the B-B cross-section of FIG. 6, and FIG. 8C illustrates an insert structure inserted into the first carrier 400.

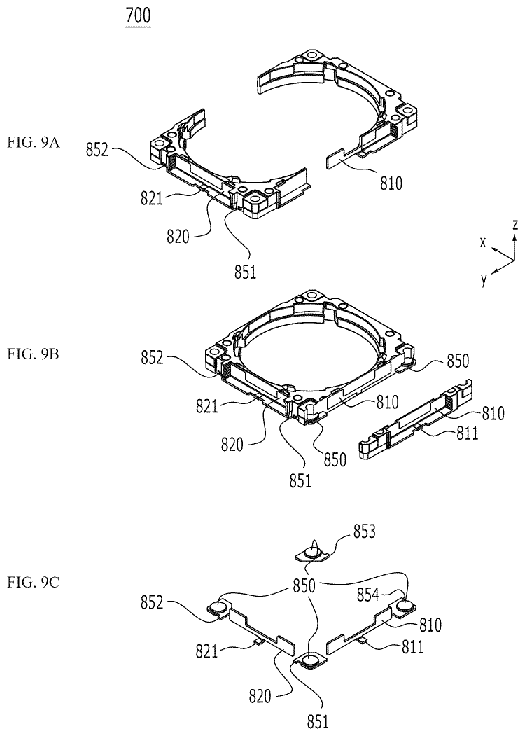

FIGS. 9A to 9C are perspective views illustrating a molded state of the second carrier 700 according to an embodiment of the present invention, in which FIG. 9A illustrates an internal structure in a state of cutting along the C-C cross-section of FIG. 6, FIG. 9B illustrates an internal structure in a state of cutting along the D-D cross-section of FIG. 6, and FIG. 9C illustrates an insert structure inserted into the second carrier 700.

FIGS. 10A and 10B are cross-sectional perspective views for illustrating an internal structure in an assembled state of the first carrier 400 and the second carrier 700 according to an embodiment of the present invention, in which FIG. 10A is a perspective view viewed from the top surface of in a state of cutting along the E-E cross-section of FIGS. 5A and 5B, and FIG. 10B is a perspective view viewed from the bottom surface.

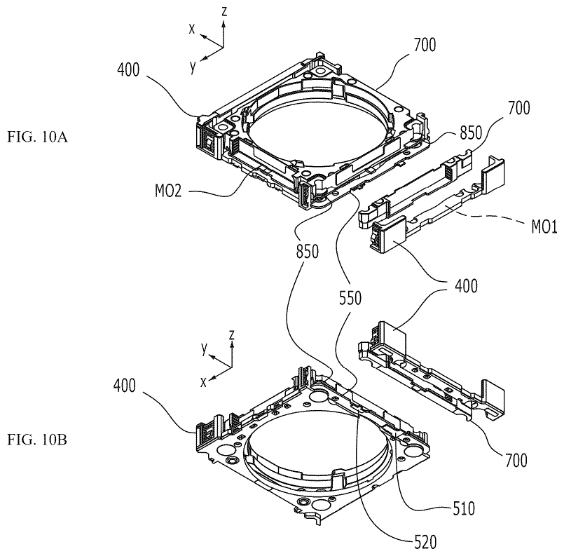

FIG. 11A is a cross-sectional perspective view in a state in which right-side members being cut out illustrated in FIG. 10A are removed and a partially enlarged cross-sectional perspective view, FIG. 11B is a cross-sectional view according to an embodiment of the present invention, and FIG. 11C is a cross-sectional view according to another embodiment of the present invention.

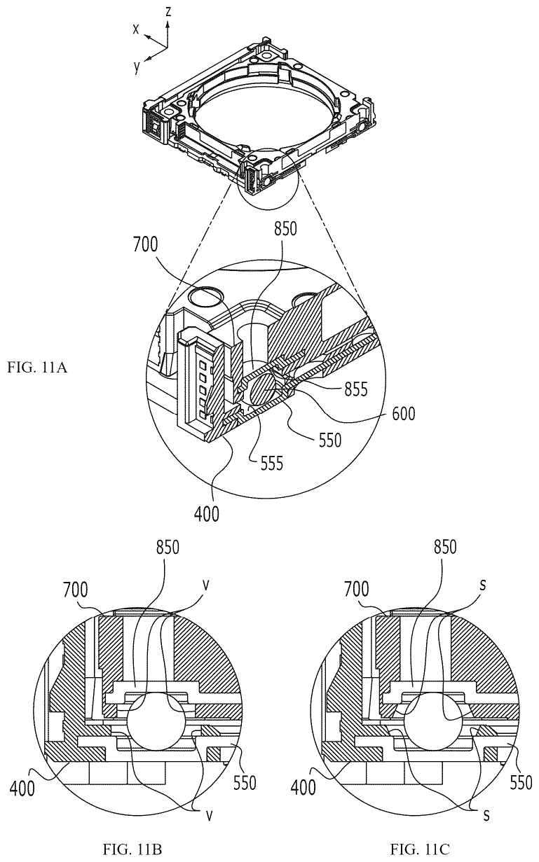

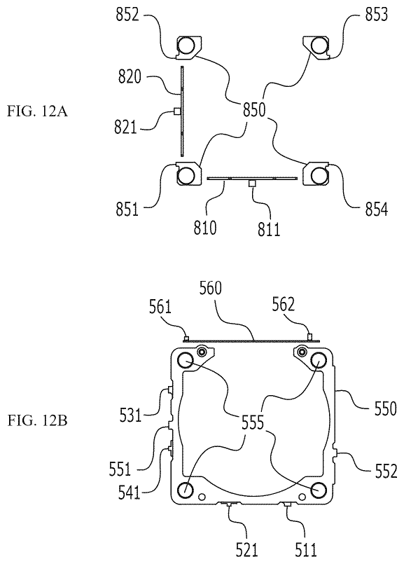

FIGS. 12A and 12B are plan views illustrating an insert structure inserted into the first carrier and the second carrier, in which FIG. 12A illustrates the insert structure inserted into the second carrier, and illustrates an insert disposition state of four second carrier reinforcing members 850, a first-direction OIS magnet yoke 810, and a second-direction OIS magnet yoke 820, and FIG. 12B illustrates an insert structure inserted into the first carrier, and illustrates a disposition state of a first carrier reinforcing member 550, an AF magnet yoke 560, and first-direction OIS suction yoke exposure portions 511 and 521, and second-direction OIS suction yoke exposure portions 531 and 541.

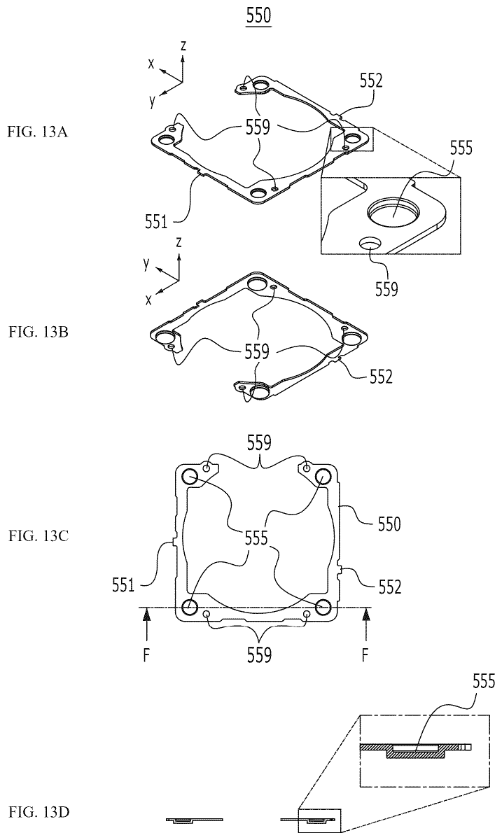

FIGS. 13A to 13D illustrate a structure of the first carrier reinforcing member 550, in which FIG. 13A is a perspective view viewed from the top surface, FIG. 13B is a perspective view viewed from the bottom surface, FIG. 13C is a plan view, and FIG. 13D is a cross-sectional view and a partially enlarged cross-sectional view taken along the F-F direction illustrated in FIG. 13C.

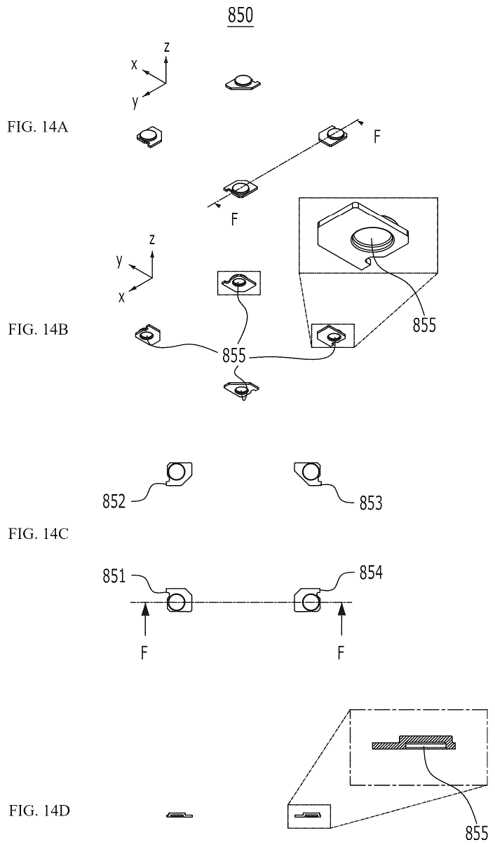

FIGS. 14A to 14D illustrate a structure of the second carrier reinforcing member 850, in which FIG. 14A is a perspective view viewed from the top surface, FIG. 14B is a perspective view viewed from the bottom surface, FIG. 14C is a plan view, and FIG. 14D is a cross-sectional view and a partially enlarged cross-sectional view taken along the F-F direction illustrated in FIG. 14C.

Examining an embodiment of the present invention with reference to the above drawings, the ball rolling portions 450 and 750 of the present invention are formed by inserting a reinforcing member into the first carrier 400 and/or the second carrier 700, in which a portion of the reinforcing member with which the balls of the reinforcing member are in contact is configured by forming a recessed flat surface.

That is, as illustrated in FIGS. 11A to 11C, the first carrier reinforcing member 550 is inserted into the first carrier 400, and the second carrier reinforcing member 850 is inserted into the second carrier 700, and recessed flat surfaces 555 and 855 in contact with the ball are formed in the first carrier reinforcing member 550 and the second carrier reinforcing member 850.

Here, the first carrier 400 may be injection-molded with a resin material in a state in which the first carrier reinforcing member 550 is inserted, and the second carrier 700 may be injection-molded with a resin material in a state in which the second carrier reinforcing member 850 is inserted.

FIG. 11B illustrates the first carrier 400 and the second carrier 700 according to an embodiment of the present invention, and illustrates that a portion where the first carrier 400 forming the ball rolling portion and the first carrier reinforcing member 550 contact, and a portion where the second carrier 700 and the second carrier reinforcing member 850 contact, are formed as a vertical surface (v).

In addition, FIG. 11C illustrates the first carrier 400 and the second carrier 700 according to another embodiment of the present invention, and illustrates that a portion where the first carrier 400 forming the ball rolling portion and the first carrier reinforcing member 550 contact, and a portion where the second carrier 700 and the second carrier reinforcing member 850 contact, are illustrated to be formed as an inclined surface(s).

When formed as the inclined surface(s) as described above, it is advantageous in securing a more available space for movement of the ball, thereby being advantageous in implementation of the OIS function, and also desirable in terms of structural rigidity by securing more portions in which the carrier body and the reinforcing member are in contact.

In addition, the first carrier reinforcing member 550 may be a plate-shaped member having a U-shape when viewed in a plane, as illustrated in FIG. 12B or FIG. 13C. That is, the first carrier reinforcing member 550 may be manufactured by punching or stamping a base material, which is a plate material, into a U-shape.

Further, the first carrier reinforcing member 550 has a recessed flat surface 555 having a predetermined area formed in each corner region, in which the recessed flat surface 555 is exposed through a hole formed in each corner surface of an injection-molded body forming the first carrier, and forms the ball rolling portion 450 for rolling motion of the ball 600 inserted between the first carrier and the second carrier, together with the hole formed in each corner surface of the injection-molded body forming the first carrier.

In addition, the second carrier reinforcing member 850 may be a plurality of plate-shaped members respectively disposed at locations where the plurality of balls are positioned, as illustrated in FIG. 12A or FIG. 14C.

The first carrier reinforcing member 550 and the second carrier reinforcing member 850 may be formed of a non-magnetic metal material, and the specific material of the first carrier reinforcing member 550 and the second carrier reinforcing member 850 may be SUS316.

Further, the recessed flat surfaces 555 and 855 of the first carrier reinforcing member 550 and the second carrier reinforcing member 850 may be formed by a drawing process.

In addition, the first carrier 400 may have a suction yoke further inserted into a position adjacent to the first carrier reinforcing member 550, in which the suction yoke may be an AF magnet yoke 560, first-direction OIS suction yokes 510 and 520, and second-direction OIS suction yokes 530 and 540.

Further, in the first carrier 400 in which the U-shaped first carrier reinforcing member 550 is inserted and formed, it is preferable that the AF magnet yoke 560 is inserted in a direction of an opening of a U-shape of the first carrier reinforcing member 550, so that, when the first carrier 400 is viewed in a plane, as illustrated in FIG. 12B, the first carrier reinforcing member 550 and the AF magnet yoke 560 are inserted as a rigid structure across the entire horizontal and vertical circumferential directions, thereby reinforcing rigidity of the first carrier 400.

Next, as illustrated in FIGS. 8A to 8C, two first-direction OIS suction yokes 510 and 520 may be disposed near the bottom surface of the first carrier reinforcing member 550 in the first direction (−x-axis direction), and the first-direction OIS suction yokes may be a first-direction suction yoke 510 having a [symbol] -shape and a first direction suction yoke 520 having a [symbol] -shape.

In addition, two second-direction OIS suction yokes 530 and 540 may be disposed near the bottom surface of the first carrier reinforcing member 550 in the second direction (y-axis direction), and the second-direction OIS suction yokes may be a second direction suction yoke 530 having a [symbol] -shape, and a second direction suction yoke 540 having a [symbol] -shape.

Further, the first-direction OIS suction yokes 510 and 520 and the second-direction OIS suction yokes 530 and 540 have first-direction OIS suction yoke exposure portions 511 and 521 and second-direction OIS suction yoke exposure portions 531 and 541 that extend from a side surface thereof and are exposed to the outside of the body of the first carrier 400.

Here, the number, shape, or material of the OIS suction yokes to be applied may be variously applied depending on the magnitude of the required suction force or the required position in a balanced state where no current is applied, and preferably, SUS430 may be applied as the material of the OIS suction yokes 510, 520, 530, and 540.

In addition, the AF magnet yoke 560 may be inserted in a vertically erected state as an elongated rectangular plate-shaped member, as illustrated in FIG. 8C, and the magnetic flux of the AF magnet coupled to the first carrier 400 may be further concentrated by the AF magnet yoke 560. Here, the specific material of the AF magnet yoke 560 may be SUS430.

Further, as illustrated in FIG. 8C and FIG. 12B, the AF magnet yoke 560 may include two AF magnet yoke exposure portions 561 and 562 that extend from both sides of a lower end portion of a vertical surface thereof in a lateral direction of the first carrier 400 and are exposed to the outside of the body of the first carrier 400.

Further, the first carrier reinforcing member 550 may have first carrier reinforcing member exposure portions 551 and 552 that extend from a side surface thereof and are exposed to the outside of the body of the first carrier 400.

Preferably, the first carrier reinforcing member exposure portions 551 and 552 may be disposed in the +y-axis direction and −y-axis direction, as illustrated in FIG. 13C. Further, the first carrier reinforcing member 550 may have two coupling holes 559 respectively formed at the upper open portion side and the lower closed portion side of a U-shape, and rivet-shaped coupling members 553 and 554 may be inserted therein, or during insert molding, a resin material may be filled into the coupling holes, so that the first carrier reinforcing member 550 may be firmly coupled to the first carrier 400.

Here, when a plurality of the first carriers 400 are simultaneously molded, the first carrier reinforcing member exposure portions 551 and 552, the AF magnet yoke exposure portions 561 and 562, the first-direction OIS suction yoke exposure portions 511 and 521, and the second-direction OIS suction yoke exposure portions 531 and 541 may be left-over configurations required in a manufacturing process in which the first carrier reinforcing members 550, the AF magnet yokes 560, the first-direction OIS suction yokes 510 and 520, and the second-direction OIS suction yokes 530 and 540, respectively corresponding to the above exposure portions, are processed by stamping or punching in a state where a plurality of them are connected in the same shape on a wide plate material and are supplied, thereafter, in a state where these yokes or reinforcing members are integrally insert injection-molded in the plurality of the first carriers 400, the respective first carriers 400 are then cut one by one.

In this case, it is preferable that the first carrier reinforcing member exposure portions 551 and 552 and the second-direction OIS suction yoke exposure portions 531 and 541 are disposed not to overlap each other when viewed in a plane, as illustrated in FIG. 12B. This is to prevent a situation in which excessive force is applied only in a specific direction to a punching tool during a punching process.

Next, the second carrier 700 according to an embodiment of the present invention may have an OIS magnet yoke further inserted between two of the plurality of second carrier reinforcing members 850.

In this case, the OIS magnet yoke inserted into the second carrier may be the first-direction OIS magnet yoke 810 that is inserted into a surface on which the first OIS magnet MO1 is seated, and the second-direction OIS magnet yoke 820 that is inserted into a surface on which the second OIS magnet MO2 is seated.

Further, these OIS magnet yokes 810 and 820 may be inserted in a vertically erected state as an elongated rectangular plate-shaped member, and the magnetic flux of the OIS magnet coupled to the second carrier 700 may be further concentrated by the OIS magnet yokes 810 and 820. Here, the specific material of the OIS magnet yokes 810 and 820 may be SUS430.

In addition, as illustrated in FIGS. 9A to 9C, the OIS magnet yokes 810 and 820 may include a first-direction OIS magnet yoke exposure portion 811 and a second-direction OIS magnet yoke exposure portion 821, which extend from a lower end portion of a vertical surface thereof in a lateral direction of the second carrier and are exposed to the outside of the body of the second carrier 700.

Further, a plurality of second carrier reinforcing members 850 may also have second carrier reinforcing member exposure portions 851, 852, 853, and 854, which extend from a side surface thereof and are exposed to the outside of the body of the second carrier 700.

Preferably, as in FIG. 14C, the second carrier reinforcing member exposure portions may be paired in twos to face each other symmetrically in the +y-axis direction and −y-axis direction, or may be paired in twos to face each other in the +x-axis direction and the −x-axis direction.

Here, when a plurality of the second carriers 700 are simultaneously molded, the second carrier reinforcing member exposure portions 851, 852, 853, and 854, the first-direction OIS magnet yoke exposure portion 811, and the second-direction OIS magnet yoke exposure portion 821 may be left-over configurations required in a manufacturing process in which the second carrier reinforcing members 850, the first-direction OIS magnet yoke 810, and the second-direction OIS magnet yoke 820, respectively corresponding to the above exposure portions, are processed by stamping or punching in a state where a plurality of them are connected in the same shape on a wide plate material and are supplied, thereafter, in a state where these yokes or reinforcing members are integrally insert injection-molded in the plurality of the second carriers 700, the respective second carriers 700 are then cut one by one.

### DESCRIPTION OF REFERENCE NUMERALS

400: First carrier
419: Guide rail
450: Ball rolling portion of first carrier
510 and 520: First-direction OIS suction yoke
511 and 521: First-direction OIS suction yoke exposure portion
530 and 540: Second-direction OIS suction yoke
531 and 541: Second-direction OIS suction yoke exposure portion
550: First carrier reinforcing member
551 and 552: First carrier reinforcing member exposure portion
553 and 554: Coupling member
555: Recessed flat surface
559: Coupling hole
560: AF magnet yoke
561 and 562: AF magnet yoke exposure portion
600: Ball
700: Second carrier
750: Ball rolling portion of second carrier
810: First-direction OIS magnet yoke
811: First-direction OIS magnet yoke exposure portion
820: Second-direction OIS magnet yoke
821: Second-direction OIS magnet yoke exposure portion
850: Second carrier reinforcing member
851, 852, 853, and 854: Second carrier reinforcing member exposure portion
855: Recessed flat surface

What is claimed is:

1. A camera actuator, comprising:
a first carrier;
a second carrier accommodated inside the first carrier;
an optical element accommodated in the second carrier,
the second carrier is movable in a plane perpendicular to an optical axis of the optical element with respect to the first carrier;
a plurality of balls provided between the first carrier and the second carrier; and
ball rolling portions provided in the first carrier and the second carrier,
wherein each ball rolling portion is configured such that a reinforcing member is inserted into the first carrier and/or the second carrier, and a recessed flat surface with which a ball comes into contact is formed in the reinforcing member.

2. The camera actuator of claim 1, wherein a first carrier reinforcing member is inserted into the first carrier, and a second carrier reinforcing member is inserted into the second carrier, and
the recessed flat surface with which the ball comes into contact is formed in the first carrier reinforcing member and the second carrier reinforcing member.

3. The camera actuator of claim 2, wherein the first carrier reinforcing member is a plate-shaped member having a U-shape when viewed in a plane.

4. The camera actuator of claim 2, wherein the second carrier reinforcing member is a plurality of plate-shaped members, and the plurality of plate-shaped members are respectively disposed at locations where a plurality of balls are positioned.

5. The camera actuator of claim 2, wherein the first carrier reinforcing member and the second carrier reinforcing member are formed of a non-magnetic metal material.

6. The camera actuator of claim 2, wherein the recessed flat surface of the first carrier reinforcing member and the second carrier reinforcing member is formed by a drawing process.

7. The camera actuator of claim 2, wherein the first carrier has a suction yoke inserted into a position adjacent to the first carrier reinforcing member.

8. The camera actuator of claim 7, wherein the suction yoke is an auto focus (AF) magnet yoke, a first-direction optical image stabilization (OIS) suction yoke, and a second-direction OIS suction yoke.

9. The camera actuator of claim 2, wherein the second carrier reinforcing member is formed of at least two reinforcing members, and an OIS magnet yoke is inserted between two of the second carrier reinforcing members in the second carrier.

10. The camera actuator of claim 9, wherein the OIS magnet yoke inserted in the second carrier is a first-direction OIS magnet yoke and a second-direction OIS magnet yoke.
